(19) United States
(12) Patent Application Publication
(10) Pub. No.: US 2007/0151066 A1
(43) Pub. Date: Jul. 5, 2007

(54) CLEANING ATTACHMENT FOR DIGITAL CAMERA

(75) Inventor: Shuzo Seo, Tokyo (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/609,461

(22) Filed: Dec. 12, 2006

(30) Foreign Application Priority Data
Dec. 13, 2005 (JP) 2005/358995

(51) Int. Cl. A47L 5/38; G02B 13/16

(52) U.S. Cl. 15/301; 348/335

(57) ABSTRACT

A cleaning attachment for removing dust stuck to a surface of an image pickup device in a camera body of a digital camera using an interchangeable lens capable of being detachably attached to a mount portion of the camera body, the cleaning attachment includes a mount portion detachably attached to the mount portion of the camera body; a facing member facing the surface of the image pickup device; a radial-air-passage forming surface, formed on a rear surface of the facing member to extend parallel to the image pickup device, for forming a radial air passage between the radial-air-passage forming surface and the image pickup device, the radial air passage extending orthogonally to an optical axis of the camera; a suction port formed in the radial-air-passage forming surface; and a suction device for producing a flow of air into the suction port through the radial air passage.

### BACKGROUND OF THE INVENTION

1. Field of the Invention

The present invention relates to a cleaning attachment designed for use in removing dust stuck to a surface of an image pickup device positioned inside a camera body of a digital camera, wherein the cleaning attachment is detachably attached to the camera body from which an interchangeable lens is detached.

2. Description of the Prior Art

A conventional cleaning attachment as described above is disclosed in, e.g., Japanese Laid-Open Patent Publication (Kokai) No. 2005-24905. The cleaning attachment disclosed in JLPP No. 2005-24905 is provided with an air blower and an air nozzle positioned in front of the image pickup device for jetting air generated by the air blower. This air is directed to an optical low-pass filter installed immediately in front of the image pickup device from the air nozzle to remove dust stuck to the front surface of the optical low-pass filter by the air pressure.

Since the aforementioned dust is stuck to the optical low-pass filter by electrostatic or intermolecular force, it is difficult to remove the dust simply by directing air to the optical low-pass filter from the air nozzle. Accordingly, the air blower conventionally needs to be large in size to remove the dust thoroughly from the optical low-pass filter.

However, an increase in size of the air blower causes an increase in size of the cleaning attachment and the production cost thereof.

### SUMMARY OF THE INVENTION

The present invention provides a cleaning attachment for removing such dust as mentioned above, wherein the cleaning attachment can blow air on the dust at a higher pressure than that of the prior art with no need to increase the size of the air blower.

According to an aspect of the present invention, a cleaning attachment is provided, for removing dust stuck to a front surface of an image pickup device provided in a camera body of a digital camera using an interchangeable lens capable of being detachably attached to a mount portion of the camera body, the cleaning attachment including a mount portion which is detachably attached to the mount portion of the camera body; a facing member which faces the front surface of the image pickup device; a radial-air-passage forming surface, formed on a rear surface of the facing member to extend parallel to the front surface of the image pickup device, for forming a radial air passage between the radial-air-passage forming surface and the front surface of the image pickup device, the radial air passage extending orthogonally to an optical axis of the camera; at least one suction port formed in the radial-air-passage forming surface; and a suction device, connected to the suction port, for producing a flow of air into the suction port through the radial air passage.

It is desirable for the cleaning attachment to include a circumferential frame provided around the facing member. The facing member includes an outer-air-passage forming surface, formed on an outer peripheral surface of the facing member, for forming an outer air passage between the outer-air-passage forming surface and an inner surface of the circumferential frame, the outer air passage being communicatively connected with the radial air passage.

It is desirable for the outer air passage and the radial air passage to be configured so that a velocity of airflow increases in a direction of flow from the outer air passage to the radial air passage.

It is desirable for the outer-air-passage forming surface and the radial-air-passage forming surface to be connected to each other via a curved surface.

It is desirable for the at least one suction port to be formed in the radial-air-passage forming surface at a position away from a center of the radial-air-passage forming surface.

It is desirable for the cleaning attachment to include a connecting body which is detachably attached to the mount portion of the camera body and supports the facing member.

It is desirable for the cleaning attachment to include a support frame immovable relative to the connecting body, wherein the facing member is supported by the support frame to be movable relative to the support frame in a direction to move toward and away from the front surface of the image pickup device. The facing member is biased in a direction away from a limit of movement thereof closest to the front surface of the image pickup device. The cleaning attachment further includes a stop mechanism for maintaining a gap between the rear surface of the facing member and the front surface of the image pickup device at a constant size when the facing member is moved to the limit of movement of the facing member.

It is desirable for the connecting body to be in the shape of a hood having an open end and a closed end at opposite ends thereof, respectively, the open end of the hood being detachably attached to the mount portion of the camera body.

It is desirable for the cleaning attachment to include at least one spacer which projects from the radial-air-passage forming surface, and comes in contact with a part of the front surface of the image pickup device which faces the periphery of an effective imaging area of the image pickup device to form the radial air passage between the front surface of the image pickup device and the radial-air-passage forming surface.

It is desirable for the image pickup device to include an image pickup element, and an optical covering element positioned immediately in front of the image pickup element.

It is desirable for the suction port to be formed at a center of the radial-air-passage forming surface.

It is desirable for the circumferential frame to have a rectangular shape in cross section taken along a plane orthogonal to the optical axis direction.

It is desirable for the connection between the outer-air-passage forming surface and the radial-air-passage forming surface to be chamfered so as to form the curved surface.

It is desirable for the at least one suction port to include two suction ports made in the radial-air-passage forming surface on opposite sides of the center thereof, respectively.

It is desirable for the digital camera to include a single-lens-reflex camera.

In an embodiment, a cleaning attachment is provided, for removing dust stuck to a front surface of an image pickup device provided in a camera body of a digital camera using an interchangeable lens capable of being detachably attached to a mount portion of the camera body, the cleaning attachment including a mount portion which is detachably attached to the mount portion of the camera body; a facing member which faces the front surface of the image pickup device; a circumferential frame provided around the facing member to form a first outer air passage and a second outer air passage between the circumferential frame and the facing member on opposite sides of the facing member, respectively; a radial-air-passage forming surface, formed on a rear surface of the facing member to extend parallel to the front surface of the image pickup device, for forming a radial air passage between the radial-air-passage forming surface and the front surface of the image pickup device, the radial air passage extending orthogonally to the optical axis and communicatively connected with each of the first outer air passage and the second outer air passage; and a suction device, communicatively connected with the second outer air passage, for producing a flow of air in a direction of flow from the first outer air passage to the second outer air passage through the radial air passage. The first outer air passage is configured so that the velocity of airflow increases in a direction of flow from the first outer air passage to the radial air passage.

It is desirable for the cleaning attachment to include a connecting body which is detachably attached to the mount portion of the camera body and supports the facing member.

It is desirable for the cleaning attachment to include a support frame immovable relative to the connecting body, wherein the facing member is supported by the support frame to be movable relative to the support frame in a direction to move toward and away from the front surface of the image pickup device. The facing member is biased in a direction to approach the front surface of the image pickup device. The cleaning attachment further includes a stop device which moves with the facing member and separates the radial-air-passage forming surface from the front surface of the image pickup device by being brought into contact with the front surface of the image pickup device to form the radial air passage between the radial-air-passage forming surface and the front surface of the image pickup device.

It is desirable for the connecting body to be in the shape of a hood having an open end and a closed end at opposite ends thereof, respectively, the open end of the hood being detachably attached to the mount portion of the camera body.

It is desirable for a connection between the first outer air passage and the radial air passage to have a curved surface, and for a connection between the second outer air passage and the radial air passage includes a curved surface.

It is desirable for the image pickup device to include an image pickup element, and an optical covering element positioned immediately in front of the image pickup element.

It is desirable for the digital camera to be a single-lens-reflex camera.

According to an aspect of the present invention, the radial air passage that extends orthogonal to an optical axis of the digital camera according to the present invention gradually decreases in the direction toward the suction port from the outer edge of the radial air passage. Therefore, the velocity of the air flow in the radial air passage gradually increases in the direction toward the suction port according to the Bernoulli effect. Since the Bernoulli effect can be expressed by the following expression: Q (quantity of flow)=A (cross-sectional area)×V (velocity of flow), the velocity of flow V increases as the cross-sectional area A reduces if the quantity of flow Q is constant. Dust stuck to the front surface of the image pickup device is removed by this accelerated airflow, and accordingly, such dust can be removed in an efficient manner with no need to increase the size of the suction device.

If the velocity of the flow of air into the radial air passage from the outer air passage is increased, the effect of removing dust stuck to the front surface of the image pickup device is enhanced.

In the case where the facing member is movable in a direction toward and away from the image pickup device, the facing member is subjected to a force biasing the facing member close to the front surface of the image pickup device because the air pressure in the radial air passage drops when air flows at a high velocity in the radial air passage. However, if the cleaning attachment is provided with the stopper mechanism or the spacer, the gap between the radial-air-passage forming surface (rear surface of the facing member) and the front surface of the image pickup device can be maintained at a constant size while the radial-air-passage forming surface and the front surface of the image pickup device can be prevented from interfering with each other.

The present disclosure relates to subject matter contained in Japanese Patent Application No. 2005-358995 (filed on Dec. 13, 2005), which is expressly incorporated herein in its entirety.

### BRIEF DESCRIPTION OF THE DRAWINGS

The present invention will be discussed below in detail with reference to the accompanying drawings, in which:

FIG. 1 is a longitudinal cross sectional view of an SLR digital camera to which a first embodiment of a cleaning attachment according to the present invention is mounted;

FIG. 2 is an enlarged longitudinal cross sectional view of a cleaner portion of the cleaning attachment, an optical covering element and a portion around the perimeter of the optical covering element;

FIG. 3 is a view similar to that of FIG. 2 in a state where a suction device is in operation;

FIG. 4 is a cross sectional view taken along IV-IV line shown in FIG. 2, viewed in the direction of the appended arrows, in a state where an inner frame of the cleaning attachment is removed;

FIG. 5 is a rear elevational view of a circumferential frame and the inner frame of the cleaning attachment, viewed from the image pickup device side;

FIG. 6 is a rear elevational view of the inner frame, illustrating the areas of cross sections of radial air passages at the respective positions thereof, taken along a plane orthogonal to an airflow direction;

FIG. 7 is a rear elevational view of a second embodiment of the cleaning attachment according to the present invention;

FIG. 8 is a cross sectional view taken along VIII-VIII line shown in FIG. 7, viewed in the direction of the appended arrows;

FIG. 9 is a view similar to that of FIG. 2, showing a state where the second embodiment of the cleaning attachment is attached to the camera body;

FIG. 10 is a cross sectional view taken along X-X line shown in FIG. 9, viewed in the direction of the appended arrows;

FIG. 11 is a cross sectional view taken along XI-XI line shown in FIG. 9, viewed in the direction of the appended arrows;

FIG. 12 is a view similar to that of FIG. 5, showing the circumferential frame and the inner frame of another embodiment of the cleaning attachment;

FIG. 13 is a view similar to that of FIG. 5, showing the circumferential frame and the inner frame of another embodiment of the cleaning attachment; and

FIG. 14 is an enlarged longitudinal sectional view of portions of the inner frame and the optical covering element that are shown in FIG. 13.

### DESCRIPTION OF THE PREFERRED EMBODIMENTS

A first embodiment of a cleaning attachment 30 which is mounted to an SLR digital camera 10 when in use will be hereinafter discussed with reference to the attached drawings. In the following description, the object side and the image-forming surface side are referred to as front side and rear side, respectively.

Firstly, the structure of a camera body 10 of the SLR digital camera to which the cleaning attachment 30 is mounted will be hereinafter discussed.

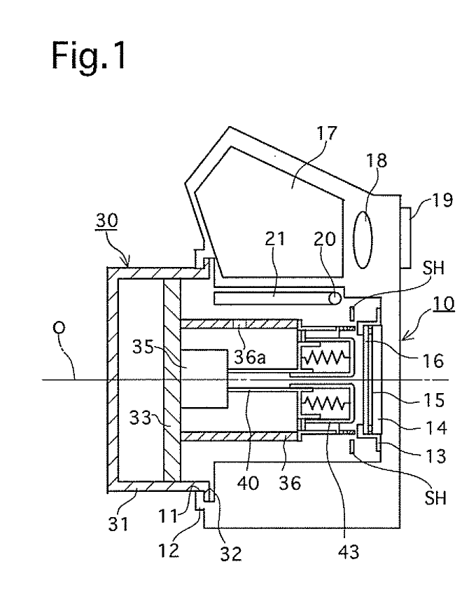

The camera body 10 is provided on a front surface of the camera body 10 with a circular opening 11, and is further provided around the circular opening 11 with a mount portion 12 in the shape of a ring as viewed from the front of the camera body 10. Ann interchangeable lens (not shown) or the cleaning attachment 30 can be freely detachably attached to the mount portion 12. The letter “O” shown in FIG. 1 designates the location of an optical axis of a photographing optical system (lens groups) provided in an interchangeable lens (not shown) when attached to the mount portion 12. The camera body 10 is provided therein with a holder 13 which is fixed to a front surface (inner surface) of a rear wall of the camera body 10. The camera body 10 is further provided therein with an image pickup element 14, and an optical covering element 16 which is positioned immediately in front of the image pickup element 14 to cover the front surface of the image pickup element 14. The image pickup element 14 and the optical covering element 16 are immovably supported by the holder 13. The optical covering element 16 can be an optical low-pass filter, an infrared cutoff filter, a cover glass, or the like. Note that the image pickup element 14 and the optical covering element 16 are elements of a solid-state image pickup device (imaging device) in this particular embodiment. Each of an imaging surface (light-receptive surface) 15 of the image pickup element 14 and the front surface of the optical covering element 16 is a flat surface orthogonal to the optical axis 0 shown in FIG. 1.

The camera body 10 is provided therein at the top of the internal space with a pentagonal prism 17, an eyepiece 18 and a viewfinder window 19, which constitute a viewfinder optical system. The camera body 10 is provided therein below the pentagonal prism 17 with a pivot (horizontal pivot shaft) 20, the opposite ends of which are rotatably supported by right and left internal walls of the camera body 10, respectively, and is further provided in the camera body 10 with a quick-return mirror 21, the rear edge of which is pivoted to the pivot 20. As known in the art,before a shutter release button (not shown) of the camera body 10 is depressed, the quick-return mirror 21 is positioned in the viewing position (down position) thereof (not shown), in which the quick-return mirror 21 is positioned at approximately 45 degrees to interfere with the optical axis 0 so as to reflect the incident light that is passed through the lens groups of the attached interchangeable lens to be incident on the quick-return mirror 21, toward the pentagonal prism 17, to allow the photographer to view an object image through the viewfinder window 19 via the eyepiece 18. On the other hand, upon the shutter release button being depressed, the mirror 21 rises to the retracted position shown in FIG. 1 to allow the image pickup element 14 to capture an image passed through the lens groups of the attached interchangeable lens. The camera body 10 is provided therein in front of the holder 13 with a focal plane shutter having of a plurality of shutter blades SH (which is in the fully opened state thereof in FIG. 1).

The structure of the cleaning attachment 30 will be discussed hereinafter.

The cleaning attachment 30 is provided with a hood portion (connecting body) 31 having a cylindrical shape, the front end (left end as viewed in FIG. 1) of which is closed. The rear end of the hood portion 31 is formed as an open end, and the hood portion 31 is provided at the rear end thereof with a mount portion 32 which can be freely detachably attached to the mount portion 12 of the camera body 10. The hood portion 31 is provided therein with an internal plate 33 which is fixed to an inner peripheral surface of the hood portion 31 and which lies in a plane orthogonal to the optical axis 0 when the hood portion 31 is attached to the mount portion 12 of the camera body 10. The cleaning attachment 30 is provided with a suction device 35 which is fixed to a rear surface of the internal plate 33 substantially at a central portion thereof. The cleaning attachment 30 is provided on the rear surface of the internal plate 33 with a rectangular hollow member 36, both the front and rear ends of which are formed as open ends. The rectangular hollow member 36 is fixed at the front end thereof to the rear surface of the internal plate 33. A connecting hole (radial through hole) 36a (see FIG. 1), through which the radially outside and the radially inside of the rectangular hollow member 36 are communicatively connected to each other, is bored through the rectangular hollow member 36.

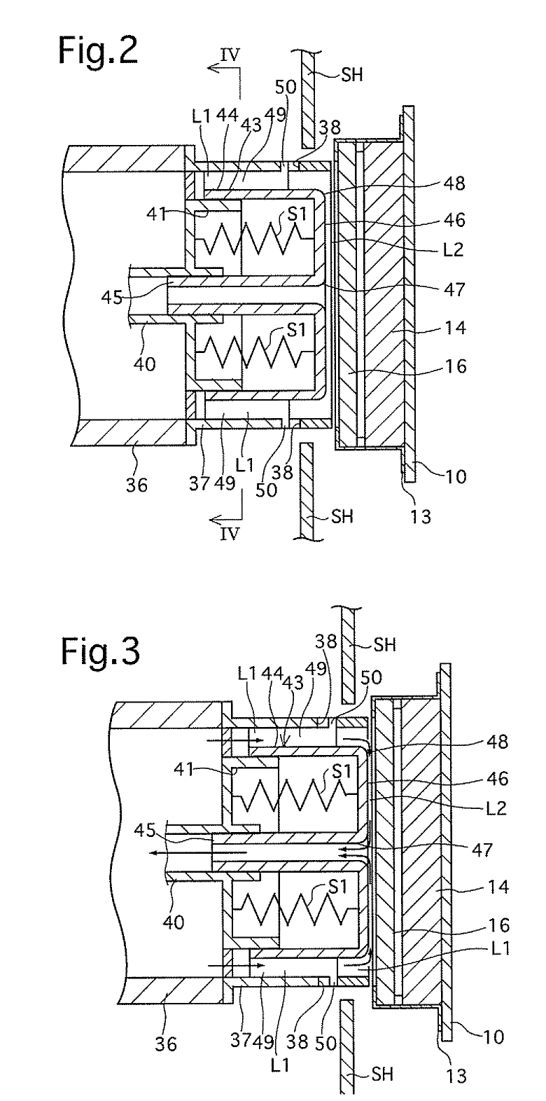

As shown in FIG. 2 in detail, the cleaning attachment 30 is provided with a circumferential frame 37 having a rectangular shape as viewed from the front thereof. A front surface of the circumferential frame 37 is fixed to a rear end surface of the rectangular hollow member 36. The circumferential frame 37 is provided, on top and bottom walls thereof in the vicinity of the rear end of the circumferential frame 37, with a pair of stop holes (elements of a stop mechanism/upper and lower stop holes) 38, respectively.

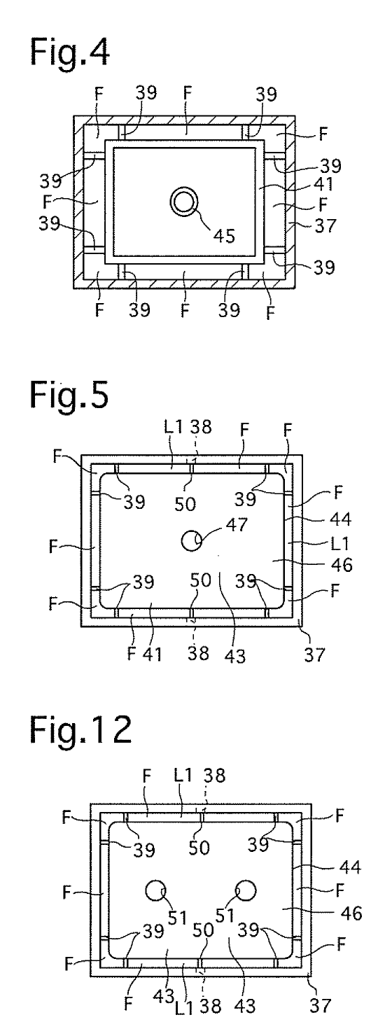

The cleaning attachment 30 is provided inside the rectangular hollow member 36 with a support cylinder 40, the front end of which extends rearward to be joined to the suction device 35. The cleaning attachment 30 is provided inside the circumferential frame 37 with a bottomed support frame 41 which is formed integral with an outer peripheral surface of the support cylinder 40. The support frame 41 and the circumferential frame 37 are coupled to each other by eight coupling pieces 39 (see FIGS. 4 and 5). The radially outer end of each coupling piece 39 is fixed to the inner peripheral surface of the circumferential frame 37 at the front end thereof, while the radially inner end of each coupling piece 39 is fixed to the outer peripheral surface of the support frame 41 at the front end thereof. Accordingly, the circumferential frame 37, the eight coupling pieces 39, the support cylinder 40 and the support frame 41 are formed as a single member by integral molding. Eight spaces (holes) are formed between the circumferential frame 37 and the support frame 41 at the front ends thereof, wherein the eight spaces are partitioned by the eight coupling pieces 39 for the separate accommodation of eight filters F that catch minute dust. The eight filters F are fixedly fitted in the aforementioned eight spaces (holes).

As shown in FIG. 4 a clearance having a rectangular shape as viewed from the front thereof is formed between the outer peripheral surface of the support frame 41 and the inner peripheral surface of the circumferential frame 37. The cleaning attachment 30 is provided inside the circumferential frame 37 with an inner frame (facing member) 43 which is fitted on the outer peripheral surface of the support frame 41 to be freely slidable thereon. The outer peripheral surface of the inner frame 43 serves as an outer-air-passage forming surface 44 for forming an outer air passage L1 between the outer-air-passage forming surface 44 and the inner peripheral surface of the circumferential frame 37. The inner frame 43 is provided at a center thereof with an integrated central cylindrical portion 45 which extends forward from the rear end of the inner frame 43. The front end of the central cylindrical portion 45 is fitted into the support cylinder 40 to be slidable on the inner peripheral surface thereof. The internal spaces of the central cylindrical portion 45 and the support cylinder 40 cooperatively form a central air passage.

The rear end surface of the inner frame 43 is formed as a flat surface parallel to the optical covering element 16 and serves as a radial-air-passage forming surface 46 in a state where the cleaning attachment 30 is mounted to the camera body 10. The rear end surface of the inner frame 43 lies in a plane substantially orthogonal to the outer-air-passage forming surface 44. A radial air passage L2 is formed between the radial-air-passage forming surface 46 and the front surface of the optical covering element 16 to extend in radial directions orthogonal to the optical axis 0 in a state where the cleaning attachment 30 is mounted to the camera body 10. The rear end opening of the central cylindrical portion 45 is open at the center of the radial-air-passage forming surface 46 to serve as a suction port 47. A rear circumferential outer edge (connecting portion/joint) 48 of the inner frame 43 that is positioned at the rear end thereof is chamfered and serves as a part of the outer-air-passage forming surface 44.

The inner frame 43 is provided, on a top surface portion and a bottom surface portion of the outer peripheral surface of the outer-air-passage forming surface 44, with an upper partition plate 49 and a lower partition plate 49 which extend in the forward/rearward direction (the direction of the optical axis 0) and which project upward and downward from the top surface and the bottom surface of the outer-air-passage forming surface 44, respectively. The top surface and the bottom surface of the outer-air-passage forming surface 44 face the pair of stop holes (upper and lower stop holes) 38, respectively. The upper partition plate 49 and the lower partition plate 49 are provided at the rear ends thereof with an upper stop projection (an element of the stop mechanism) 50 and a lower stop projection (an element of the stop mechanism) 50 which extend radially outwards and are engaged in the upper and lower stop holes 38 to be slidingly movable therein in the optical axis direction (horizontal direction as viewed in FIGS. 1 through 3), respectively. Namely, the inner frame 43 is slidingly movable in the forward/rearward direction relative to the circumferential frame 37 and the support frame 41 between the front moving limit (the position shown in FIG. 2) defined by the engagement of each stop projection 50 with the front end of the associated stop hole 38 and the rear moving limit (the position shown in FIG. 3) defined by the engagement of each stop projection 50 with the rear end of the associated stop hole 38. Additionally, the cleaning attachment 30 is provided with extension springs (biasing device) S1 which are extended and installed between the base (rearward-facing surface) of the support frame 41 and the rear end wall of the inner frame 43. Specifically, the front ends and the rear ends of the extension springs S1 are fixed to the base of the support frame 41 and the rear end wall of the inner frame 43, respectively, so that the inner frame 43 is continuously biased forward, away from the front surface of the optical covering element 16, by the pulling spring force of the extension springs S1.

The procedure for cleaning the front surface of the optical covering element 16 with the cleaning attachment 30 having the above described structure will be discussed hereinafter.

First of all, by an operation of a specific switching mechanism (for example, by pushing a cleaning switch button provided on the camera body (not shown)), the shutter blades SH of the focal plane shutter are fully opened and the mirror 21 moves to the retracted position. Subsequently, the cleaning attachment 30 is mounted to the camera body 10 by coupling the mount portion 32 of the cleaning attachment 30 to the mount portion 12 of the camera body 10 from which an interchangeable lens is detached. In a state where the cleaning attachment 30 is mounted to the camera body 10, dust is prevented from entering the inside of the camera body 10 through the circular opening 11 by the hood portion 31. Thereupon, as shown in FIGS. 2 and 3, the rear end of the circumferential frame 37 passes through the fully-opened aperture of the focal plane shutter (having the shutter blades SH) and approaches the optical covering element 16.

Subsequently, upon the cleaning attachment 30 being mounted to the camera body 10, the radial-air-passage forming surface 46 is positioned closely to the front surface of the optical covering element 16 to be parallel thereto as shown in FIG. 2 to form the radial air passage L2 between the radial-air-passage forming surface 46 and the front surface of the optical covering element 16. Note that the clearance created between the rear end surface of the circumferential frame 37 and the front surface of the optical covering element 16 is minimal as shown in FIGS. 2 and 3. In addition, the outer air passage L1 is already formed between the inner frame 43 (the outer-air-passage forming surface 44 and the rear circumferential outer edge 48) and the circumferential frame 37 before the cleaning attachment 30 is mounted to the camera body 10.

Upon the suction device 35 being actuated in the state shown in FIG. 2, the negative pressure produced by the suction device 35 causes the air outside the rectangular hollow member 36 to firstly enter inside the rectangular hollow member 36 through the connecting hole 36a and subsequently flow in the directions shown by the arrows shown in FIG. 3. Namely, the air flowing into the rectangular hollow member 36 flows into the radial air passage L2 through the outer air passage L1, subsequently flows into the central air passage, which is formed by the central cylindrical portion 45 and the support cylinder 40, via the suction port 47, and is ultimately sucked by the suction device 35. At this time, this air flows from the outer air passage L1 into the radial air passage L2 along the curved surface (chamfered corner) of the rear circumferential outer edge 48 of the inner frame 43 with a Coanda effect (boundary layer attachment), and therefore flows from the outer air passage L1 into the radial air passage L2 efficiently.

The dimensions of the outer air passage L1 and the radial air passage L2 are determined so that the area of a cross section of the radial air passage L2 taken along a plane orthogonal to the direction of the airflow in the radial air passage L2 becomes smaller than the area of a cross section of the outer air passage L1 taken along a plane orthogonal to the direction of the airflow in the outer air passage L1. More specifically, the following expression is satisfied:
CA1>CA2

wherein CA1 represents the area of a cross section of the outer air passage L1 taken along a plane orthogonal to the direction of the airflow in the outer air passage L1, and CA2 represents the area of a cross section of the radial air passage L2 taken along a plane orthogonal to the direction of the airflow in the radial air passage L2.

Therefore, when air flows into the outer edge of the radial air passage L2 from the outer air passage L1, the velocity of this airflow increases by a decrease in cross-sectional area of the air passage (Bernoulli effect). Namely, the following expression is satisfied:
V2>V1

wherein V1 represents the velocity of the airflow in the outer air passage L1, and

V2 represents the velocity of the airflow in the radial air passage L2.

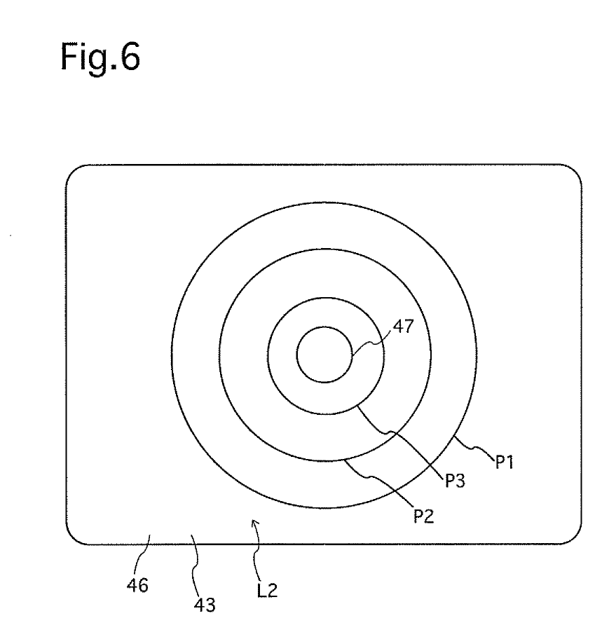

As shown in FIG. 6, the area of a cross section of the radial air passage L2 taken along a plane orthogonal to the direction of the airflow in the radial air passage L2 gradually decreases in the direction toward the suction port 47 (the central air passage) from the outer edge of the radial air passage L2. FIG. 6 shows ring-shaped sections P1, P2 and P3 which are concentrically arranged about the suction port 47. The following expression is satisfied:
CA1>CA2>CA3>CA4>CA5

wherein CA3, CA4 and CA5 represent the area of a cross section of the ring-shaped section P1 taken along a plane orthogonal to the direction of the airflow in the ring-shaped section P1, the area of a cross section of the ring-shaped section P2 taken along a plane orthogonal to the direction of the airflow in the ring-shaped section P2, and the area of a cross section of the ring-shaped section P3 taken along a plane orthogonal to the direction of the airflow in the ring-shaped section P3, respectively.

Therefore, the following expression is satisfied:
V5>V4>V3>V2>V1

wherein V3 represents the velocity of the airflow in the ring-shaped section P1,

V4 represents the velocity of the airflow in the ring-shaped section P2, and

V5 represents the velocity of the airflow in the ring-shaped section P3.

The airflow accelerated in this manner from the airflow velocity V1 to the air velocity V5 removes dust stuck to the front surface of the optical covering element 16, and accordingly, such dust on the front surface of the optical covering element 16 can be reliably removed with no need to increase the size of the suction device 35 in order to produce a greater suction power.

The passage of air through the radial air passage L2 at the airflow velocities V2, V3, V4 and V5 in this order causes the air pressure in the radial air passage L2 to become lower than that before the actuation of the suction device 35. This reduction of the air pressure in the radial air passage L2 causes the inner frame 43 to move rearward to the aforementioned rear moving limit thereof against the pulling spring force of the extension springs S1 i.e., to the position shown in FIG. 3. If the width of the radial air passage L2 in the optical axis direction further narrows in this manner, the velocity of the air passing through the radial air passage L2 becomes higher than that before the inner frame 43 moves rearward, which makes it possible to remove dust stuck to the front surface of the optical covering element 16 in a more efficient manner.

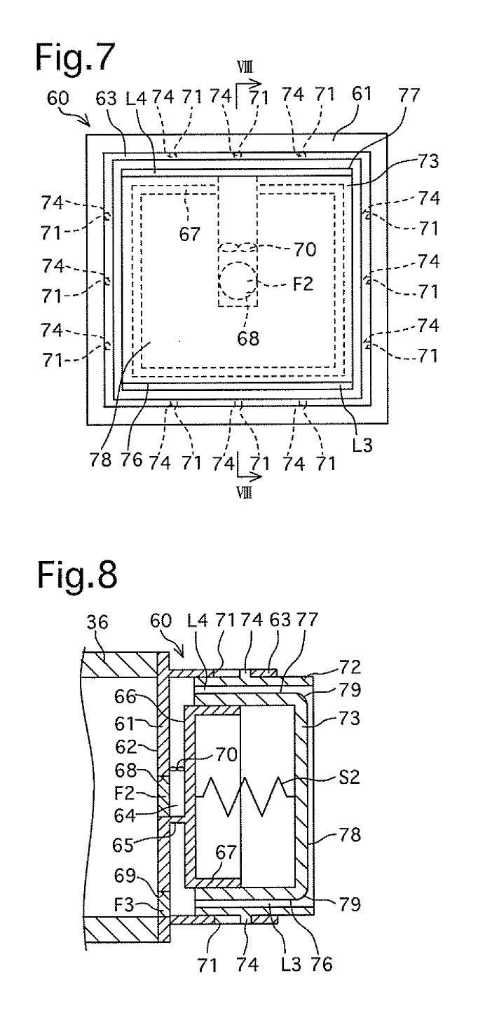

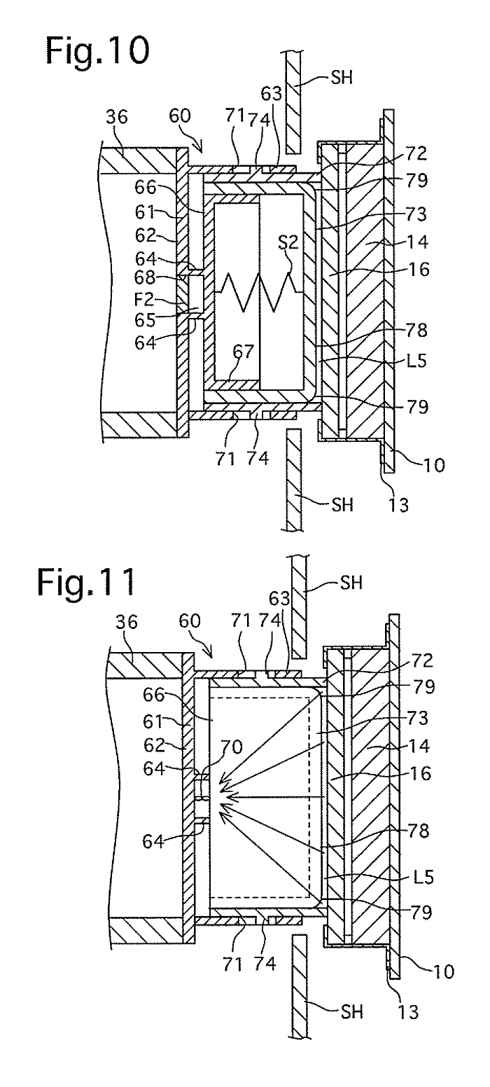

A second embodiment of a cleaning attachment 60 according to the present invention will be hereinafter discussed with reference to FIGS. 7 through 11. Elements of the second embodiment of the cleaning attachment 60 which are similar to those of the first embodiment of the cleaning attachment 30 are designated by the same reference numerals, and a detailed description of such elements are omitted from the following description.

The second embodiment of the cleaning attachment 60 is provided with a support frame 61 which is fixed to a rear end surface of the rectangular hollow member 36.

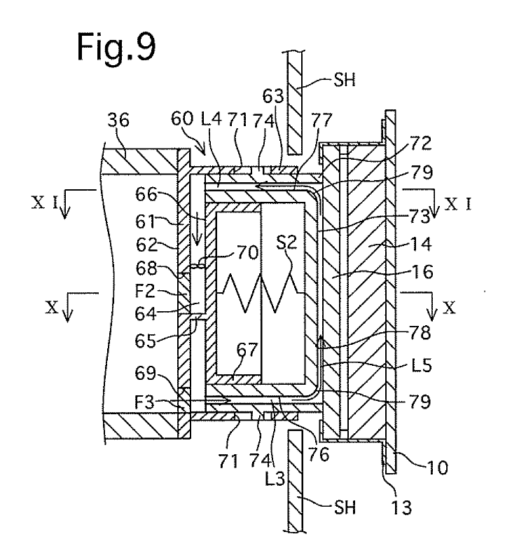

The support frame 61 is provided with a fixing portion 62 in the shape of a flat plate which is fixed to the rear end surface of the rectangular hollow member 36, and is provided with an outer rectangular hollow portion 63 which is integral with the fixing portion 62 and projects from the rear end surface of the rectangular hollow member 36. The support frame 61 is further provided on a rear surface of the fixing portion 62 with a pair of air-passage forming wall portions 64 and an end wall portion 65 which are integral with the fixing portion 62. The pair of air-passage forming wall portions 64 extend rearward so as to be parallel to each other, and the end wall portion 65 also extends rearward to close one of the two gaps (specifically, the bottom gap as viewed in FIGS. 8 and 9) respectively made at the opposite ends (the top and bottom ends as viewed in FIGS. 8 and 9) of the pair of air-passage forming wall portions 64. The support frame 61 is further provided immediately behind the pair of air-passage forming wall portions 64 and the end wall portion 65 with a support portion 66 in the shape of a flat plate which is integrally fixed to rear end surfaces of the pair of air-passage forming wall portions 64 and the end wall portion 65. The support frame 61 is further provided immediately behind the support portion 66 with an inner rectangular hollow portion (support frame) 67 which is integral with the support portion 66 and projects rearward from the outer edge of the rear end surface of the support portion 66.

The fixing portion 62 is provided between the front ends of the pair of the air-passage forming wall portions 64 with a through hole 68 in which a filter F2 is fixedly fitted. The fixing portion 62 is further provided with a through hole 69 (see FIG. 8 and 9) in which a filter F3 is fixedly fitted. The cleaning attachment 60 is provided, in an air passage formed among the pair of air-passage forming wall portions 64, the end wall portion 65 and the support portion 66, with a fan 70 serving as a suction device. The outer rectangular hollow portion 63 is provided with twelve guide support holes 71 which are elongated in the forward/rearward direction and arranged circumferentially at predetermined intervals.

As shown in FIG. 7, the cleaning attachment 60 is provided between the outer rectangular hollow portion 63 and the inner rectangular hollow portion 67 of the support frame 61 with a clearance (receptive space) having a rectangular shape as viewed from the front thereof, and is provided in this clearance with an outer frame (circumferential frame/stop device) 72 and an inner frame (facing member) 73 which are integrally formed with each other (see FIG. 8). The outer frame 72 is slidably fitted in the outer rectangular hollow portion 63 to be slidingly movable in the forward/rearward direction relative to the outer rectangular hollow portion 63, and the inner frame 73 is slidably fitted on the inner rectangular hollow portion 67 to be slidingly movable in the forward/rearward direction relative to the inner rectangular hollow portion 67.

The outer frame 72, the outer peripheral surface of which is in contact with the inner peripheral surface of the outer rectangular hollow portion 63 to be slidable thereon, is provided at twelve positions on the outer peripheral surface thereof, which respectively correspond the positions of the twelve guide support holes 71, with twelve guide projections 74 which are engaged in the twelve guide support holes 71 to be slidingly movable in the forward/rearward direction relative to the twelve guide support holes 71, respectively.

As shown in FIG. 7, right and left outer side surfaces of the inner frame 73 are firmly fitted to right and left inner side surfaces of the outer frame 72 to be fixed thereto with no gap therebetween, respectively. The bottom surface of the inner frame 73 serves as a first outer-air-passage forming surface 76, and a first outer air passage L3 is formed between the first outer-air-passage forming surface 76 and the bottom wall 5 portion of the outer frame 72. The top surface of the inner frame 73 serves as a second outer-air-passage forming surface 77, and a second outer air passage L4 is formed between the second outer-air-passage forming surface 77 and the top wall portion of the outer frame 72. The rear end surface of the inner frame 73 serves as a radial-air-passage forming surface 78 which is formed as a flat surface parallel to the optical covering element 16. The outer frame also separates the radial-air-passage forming surface 78 from the optical covering element 16, as shown in FIGS. 9 through 11.

Similar to the rear circumferential outer edge 48 of the inner frame 43 in the first embodiment of the cleaning attachment 30, a rear circumferential outer edge 79 of the inner frame 73 that is positioned at the rear end thereof is chamfered and serves as a part of the first outer-air-passage forming surface 76 and apart of the second outer-air-passage forming surface 77. The rear circumferential outer edge 79 of the inner frame 73 also serves as a connecting portion by which the radial-air-passage forming surface 78 and the first outer-air-passage forming surface 76 are connected, and also serves as a connecting portion by which the radial-air-passage forming surface 78 and the second outer-air-passage forming surface 77 are connected. As shown in the drawings, the cleaning attachment 60 is provided with compression springs (biasing device) S2 which are compressed so as to be installed between the a rear surface of the support portion 66 and a front surface of the rear end wall of the inner frame 73. Therefore, the outer frame 72 and the inner frame 73 are continuously biased rearward by the compression springs S2 to bring the twelve guide projections 74 to be biased against the rear ends of the twelve guide support holes 71, respectively, as shown in FIG. 8.

The procedure for cleaning the front surface of the optical covering element 16 with the cleaning attachment 60 that has the above described structure will be discussed hereinafter.

First of all, likewise with the first embodiment, in the state where the quick-return mirror 21 is retracted to the position shown in FIG. 1 and the focal plane shutter SH being fully opened, the cleaning attachment 60 is mounted to the camera body 10 by coupling the mount portion 32 of the cleaning attachment 60 to the mount portion 12 of the camera body 10 from which an interchangeable lens is detached. At this time, the rear end of the outer frame 72 passes through the fully-opened aperture of the focal plane shutter (consisting of the shutter blades SH) and comes into contact with the front surface of the optical covering element 16 as shown in FIGS. 9 through 11. Thereupon, as shown in FIGS. 9 through 11, the outer frame 72 and the inner frame 73 move forward relative to the outer rectangular hollow portion 63 against the biasing force of the compression springs S2, while the radial-air-passage forming surface 78 of the inner frame 73 which approaches the front surface of the optical covering element 16 parallel to the radial-air-passage forming surface 78 forms a radial air passage L5 between the radial-air-passage forming surface 78 and the front surface of the optical covering element 16.

Upon the fan 70 being actuated in the state shown in FIG. 9, the negative pressure produced by the fan 70 causes the air which exists outside the rectangular hollow member 36 to firstly enter inside the rectangular hollow member 36 through the connecting hole 36a, and subsequently flow in the directions shown by the arrows shown in FIG. 9. Namely, the air flowing into the rectangular hollow member 36 firstly flows into the first outer air passage L3, subsequently flows from the first outer air passage L3, the radial air passage L5 to the second outer air passage L4 in that order (see the arrows shown in FIGS. 9 through 11), subsequently passes through the fan 70 and flows back into the rectangular hollow member 36 through the filter F2. At this time, this air flows from the first outer air passage L3 to the radial air passage L5 along the curved surface (chamfered corner) of the rear circumferential outer edge 79 of the inner frame 73 with a Coanda effect (boundary layer attachment), and subsequently flows from the radial air passage L5 to the second outer air passage L4 along the curved surface (chamfered corner) of the rear circumferential outer edge 79 of the inner frame 73 with a Coanda effect (boundary layer attachment), and accordingly flows from the first outer air passage L3 to the second outer air passage L4 efficiently.

Similar to the outer air passage L1 and the radial air passage L2 in the first embodiment of the cleaning attachment 30, the dimensions of the first outer air passage L3, the second outer air passage L4 and the radial air passage L5 are determined so that the area of a cross section of the radial air passage LS taken along a plane orthogonal to the direction of the airflow in the radial air passage L5 becomes smaller than each of the area of a cross section of the first outer air passage L3 taken along a plane orthogonal to the direction of the airflow in the first outer air passage L3 (which includes the area of a cross section of a portion of the first outer air passage L3 which is formed between the rear circumferential outer edge 79 and the outer frame 72) and the area of a cross section of second outer air passage L4 taken along a plane orthogonal to the direction of the airflow in second outer air passage L4 (which includes the area of a cross section of a portion of the second outer air passage L4 which is formed between the rear circumferential outer edge 79 and the outer frame 72) Therefore, when air flows into the outer edge of the radial air passage L5 from the first outer air passage L3, the velocity of this airflow increases by a decrease in cross-sectional area of the air passage. Namely, the following expression is satisfied:
V2>V1

wherein V1 represents the velocity of the airflow in the outer air passage L3, and

V2 represents the velocity of the airflow in the radial air passage L5.

The airflow accelerated in this manner from the airflow velocity VI to the air velocity V2 removes dust stuck to the front surface of the optical covering element 16, and accordingly, such dust on the front surface of the optical covering element 16 can be reliably removed, and similar to the first embodiment of the cleaning attachment 30, there is no need to increase the size of the suction device 35 in order to produce a greater suction power.

Although the present invention has been discussed with reference to the specific embodiments described above, the present invention is not limited solely thereto; various changes can be made in these specific embodiments without departing from the scope of the invention claimed.

For instance, it is possible that the cleaning attachment be provided, on the radial-air-passage forming surface 46 at two positions thereon laterally away from the center of the radial-air-passage forming surface 46, with two suction ports 51 (each of which corresponds to the suction port 47 shown in FIG. 5) as shown in FIG. 12 in the first embodiment of the cleaning attachment (the two suction ports 51 are communicatively connected to the suction device 35 although the structure thereof is not shown in the drawings). The two portions of the radial-air-passage forming surface 46 in which the two suction ports 51 are made are portions of the radial-air-passage forming surface 46 where there is a possibility of the airflow stagnating in the case where no suction ports are made. Therefore, if the airflow stagnates at the two portions of the radial-air-passage forming surface 46, dust will remain on two portions (portions having a harmful effect on image quality if having dust thereon) of the front surface of the optical covering element 16 which face the two portions of the radial-air-passage forming surface 46, respectively. However, providing the two suction ports 51 in this manner makes it possible to effectively prevent such dust stuck to such two portion of the front surface of the optical covering element 16 from remaining.

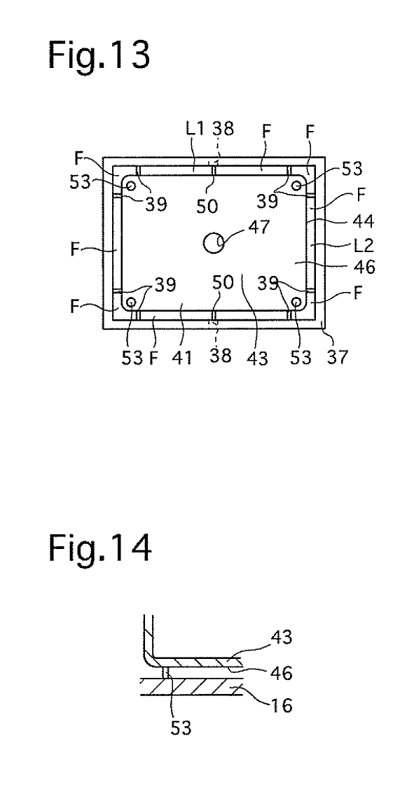

Additionally, in the embodiment shown in FIGS. 13 and 14, it is possible for four spacers (spacers for formation of an air passage) 53, which come in contact with the front surface of the optical covering element 16 when the inner frame 43 is drawn toward the optical covering element 16 upon the air pressure in the outer air passage L1 falling, be installed at four portions of the radial-air-passage forming surface 46 in the vicinity of the four corners thereof, respectively, which face the periphery of the effective imaging area of the imaging surface 15. By providing the spaces 53 in such a manner, the length (thickness) of the outer air passage L1 in the forward/rearward direction, which is formed between the radial-air-passage forming surface 46 and the optical covering element 16, can be freely set by freely determining the thickness of the spacers 53 in the forward/rearward direction, and accordingly, the effect of removing dust stuck to the optical covering element 16 can be adjusted by freely determining the thickness of the spacers 53 in the forward/rearward direction.

If the camera body 10 is not provided with the optical covering element 16, the imaging surface 15 of the image pickup element 14 can be cleaned by airflow from the cleaning attachment (30 or 60).

It is possible that the support cylinder 40 be replaced by a connecting tube made of rubber.

Obvious changes may be made in the specific embodiments of the present invention described herein, such modifications being within the spirit and scope of the invention claimed. It is indicated that all matter contained herein is illustrative and does not limit the scope of the present invention.

What is claimed is:

1. A cleaning attachment for removing dust stuck to a front surface of an image pickup device provided in a camera body of a digital camera using an interchangeable lens capable of being detachably attached to a mount portion of said camera body, said cleaning attachment comprising:
a mount portion which is detachably attached to said mount portion of said camera body;
a facing member which faces said front surface of said image pickup device;
a radial-air-passage forming surface, formed on a rear surface of said facing member to extend parallel to said front surface of said image pickup device, for forming a radial air passage between said radial-air-passage forming surface and said front surface of said image pickup device, said radial air passage extending orthogonally to an optical axis of the camera;
at least one suction port formed in said radial-air-passage forming surface; and
a suction device, connected to said suction port, for producing a flow of air into said suction port through said radial air passage.

2. The cleaning attachment according to claim 1, further comprising a circumferential frame provided around said facing member,
wherein said facing member comprises an outer-air-passage forming surface, formed on an outer peripheral surface of said facing member, for forming an outer air passage between said outer-air-passage forming surface and an inner surface of said circumferential frame, said outer air passage being communicatively connected with said radial air passage.

3. The cleaning attachment according to claim 2, wherein said outer air passage and said radial air passage are configured so that a velocity of airflow increases in a direction of flow from said outer air passage to said radial air passage.

4. The cleaning attachment according to claim 1, wherein said outer-air-passage forming surface and said radial-air-passage forming surface are connected to each other via a curved surface.

5. The cleaning attachment according to claim 1, wherein said at least one suction port is formed in said radial-air-passage forming surface at a position away from a center of said radial-air-passage forming surface.

6. The cleaning attachment according to claim 1, further comprising a connecting body which is detachably attached to said mount portion of said camera body and supports said facing member.

7. The cleaning attachment according to claim 6, further comprising a support frame immovable relative to said connecting body,
wherein said facing member is supported by said support frame to be movable relative to said support frame in a direction to move toward and away from said front surface of said image pickup device,
wherein said facing member is biased in a direction away from a limit of movement thereof closest to said front surface of said image pickup device, and
wherein said cleaning attachment further comprises:
a stop mechanism for maintaining a gap between said rear surface of said facing member and said front surface of said image pickup device at a constant size when said facing member is moved to said limit of movement of said facing member.

8. The cleaning attachment according to claim 6, wherein said connecting body is in the shape of a hood having an open end and a closed end at opposite ends thereof, respectively, said open end of said hood being detachably attached to said mount portion of said camera body.

9. The cleaning attachment according to claim 1, further comprising at least one spacer which projects from said radial-air-passage forming surface, and comes in contact with a part of said front surface of said image pickup device which faces the periphery of an effective imaging area of said image pickup device to form said radial air passage between said front surface of said image pickup device and said radial-air-passage forming surface.

10. The cleaning attachment according to claim 1, wherein said image pickup device comprises:
an image pickup element, and
an optical covering element positioned immediately in front of said image pickup element.

11. The cleaning attachment according to claim 1, wherein said suction port is formed at a center of said radial-air-passage forming surface.

12. The cleaning attachment according to claim 2, wherein said circumferential frame has a rectangular shape in cross section taken along a plane orthogonal to said optical axis direction.

13. The cleaning attachment according to claim 4, wherein said connection between said outer-air-passage forming surface and said radial-air-passage forming surface is chamfered so as to form said curved surface.

14. The cleaning attachment according to claim 5, wherein said at least one suction port comprises two suction ports made in said radial-air-passage forming surface on opposite sides of said center thereof, respectively.

15. The cleaning attachment according to claim 1, wherein said digital camera comprises a single-lens-reflex camera.

16. A cleaning attachment for removing dust stuck to a front surface of an image pickup device provided in a camera body of a digital camera using an interchangeable lens capable of being detachably attached to a mount portion of said camera body, said cleaning attachment comprising:
a mount portion which is detachably attached to said mount portion of said camera body;
a facing member which faces said front surface of said image pickup device;
a circumferential frame provided around said facing member to form a first outer air passage and a second outer air passage between said circumferential frame and said facing member on opposite sides of said facing member, respectively;
a radial-air-passage forming surface, formed on a rear surface of said facing member to extend parallel to said front surface of said image pickup device, for forming a radial air passage between said radial-air-passage forming surface and said front surface of said image pickup device, said radial air passage extending orthogonally to said optical axis and communicatively connected with each of said first outer air passage and said second outer air passage; and
a suction device, communicatively connected with said second outer air passage, for producing a flow of air in a direction of flow from said first outer air passage to said second outer air passage through said radial air passage,
wherein said first outer air passage is configured so that the velocity of airflow increases in a direction of flow from said first outer air passage to said radial air passage.

17. The cleaning attachment according to claim 16, further comprising a connecting body which is detachably attached to said mount portion of said camera body and supports said facing member.

18. The cleaning attachment according to claim 17, further comprising a support frame immovable relative to said connecting body,
wherein said facing member is supported by said support frame to be movable relative to said support frame in a direction to move toward and away from said front surface of said image pickup device
wherein said facing member is biased in a direction to approach said front surface of said image pickup device, and
wherein said cleaning attachment further comprises:
a stop device which moves with said facing member and separates said radial-air-passage forming surface from said front surface of said image pickup device by being brought into contact with said front surface of said image pickup device to form said radial air passage between said radial-air-passage forming surface and said front surface of said image pickup device.

19. The cleaning attachment according to claim 17, wherein said connecting body is in the shape of a hood having an open end and a closed end at opposite ends thereof, respectively, said open end of said hood being detachably attached to said mount portion of said camera body.

20. The cleaning attachment according to claim 16, wherein a connection between said first outer air passage and said radial air passage comprises a curved surface, and
wherein a connection between said second outer air passage and said radial air passage comprises a curved surface.

21. The cleaning attachment according to claim 16, wherein said image pickup device comprises:
an image pickup element, and
an optical covering element positioned immediately in front of said image pickup element.

22. The cleaning attachment according to claim 16, wherein said digital camera comprises a single-lens-reflex camera.
